(19) United States
(12) Patent Application Publication
(10) Pub. No.: US 2002/0178118 A1
(43) Pub. Date: Nov. 28, 2002

(54) Transaction based packet switched data service on a wireless network

(76) Inventors: Thomas E. Hamilton, Marlborough, MA (US); Simon Cavenett, Roswell, GA (US)

Correspondence Address: KENNETH F. KOZIK, Fish & Richardson P.C., 225 Franklin Street, Boston, MA, 02110-2804, US

(21) Appl. No.: 10/066,156

(22) Filed: Feb. 1, 2002

Related U.S. Application Data
(60) Provisional application No. 60/293,756, filed on May 25, 2001.

(51) Int. Cl. G06F 17/60

(52) U.S. Cl. 705/40

(57) ABSTRACT

A method of providing transaction-based packet switched data services on a wireless network is presented. A method of managing a wireless network includes receiving a user request for a packet switched data service, determining a provider for the service according to stored policies, and determining a billing arrangement for the service according to the stored policies.

### CROSS-REFERENCE TO RELATED APPLICATIONS

This application claims the benefit of U.S. Provisional Application No. 60/293,756 filed May 25, 2001, “Method for Transaction Based Packet Switched Data Services on a Wireless Network”. This application is incorporated herein by reference.

### FIELD OF THE INVENTION

The present invention relates to transaction based packet switched data services on a wireless network.

### BACKGROUND OF THE INVENTION

With the growth of the Internet, a great deal of information and services are available to a network that can handle packet switched data in TCP/IP protocol. To provide a suitable bearer for packet switched data protocols, such as TCP ring protocol for multicast use (TCPRP), so-called second generation wireless systems support Circuit Switched Data (CSD). To overcome data rate limitations of CSD, a variation of CSD is available for Global System for Mobile communication (GSM) called High Speed Circuit Switched Data (HSCSD). HSCSD combines multiple individual channels (time slots) for an aggregate data transmission bearer. To enable the second generation networks to more optimally provide a bearer service for packet switched data, upgrade technologies such as the General Packet Radio System (GPRS) have been developed as an augmentation of the GSM system technology.

### SUMMARY

In an aspect, the invention features a method including, in a wireless network, receiving a user request for a packet switched data service, determining a provider for the service according to stored policies, and determining a billing arrangement for the service according to the stored policies.

Embodiments may include one or more of the following.

The stored polices may include how the user is to be billed and a basis for the billing, policy decisions that are entrusted to the provider, and/or pre-arrangements between an operator of the network and the provider. The stored policies may include matching a provider to a user's time of connection, matching a provider to a user's location, matching a provider to a time of day, matching a provider to a user class, matching a provider to a service class, and/or matching a provider to network conditions.

The method may also include determining whether the user is authorized to use the service. Determining may include checking a user account for payment history. The method may also include billing the user upon completion of a user session, and reconciling billing between a network operator and the provider. The user session may include multiple transaction sessions.

The wireless network may be a second generation wireless network. The wireless network may be a Global System for Mobile communication (GSM) network, and the GSM network may be General Packet Radio System (GPRS) enabled.

The wireless network may be a Time Division Multiple Access (TDMA) network, a Code Division Multiple Access (CDMA) network, Universal Mobile Telecommunications System (UMTS) network, a TETRA network, a Tetrapol network, A DECT network, an AMPS network, or a wireless local area network (WLAN). The wireless network may be a third generation wireless network.

In another aspect, the invention features a method of managing a General Packet Radio System (GPRS) enabled Global System for Mobile communication (GSM) network including receiving a user request for a packet switched data service, determining a provider for the service according to stored policies, and determining a billing arrangement for the service according to the stored policies.

Embodiments may include one or more of the following.

The stored polices may include how the user is to be billed and a basis for the billing, and policy decisions that are entrusted to the provider. The stored policies may include pre-arrangements between an operator of the network and the provider.

The stored policies may include matching a provider to a user's time of connection, matching a provider to a user's location, matching a provider to a time of day, matching a provider to a user class, matching a provider to a service class, and/or matching a provider to network conditions.

The method may also include determining whether the user is authorized to use the service. Determining may include checking a user account for payment history and may also include billing the user upon completion of a user session, and reconciling billing between a network operator and the provider. The user session may include multiple transaction sessions.

In another aspect, the invention features in a General Packet Radio System (GPRS) enabled Global System for Mobile Communication (GSM) network, collecting call data records (CDRs) from a Serving GPRS support node in the network, sending the CDRs to a charging gateway in the network, processing the CDRs for packet switched data into a single composite CDR stream in the charging gateway, and processing the single composite CDR stream in a billing system.

Embodiments may include one of more of the following.

Collecting may also include collecting CDRs from a GPRS support node. Processing the CDRs may include augmenting the CDRs for packet switched data in a billing mediation node.

The single composite CDR stream may represent a user session. The user session may include a number of individual purchase sessions.

Processing the single composite CDR stream may include checking for records duplication, correlating information, and validating.

In another aspect, the invention features a method of providing a sponsored packet switch data service including in a GPRS enabled GSM network, receiving a request for a packet switched data service, selecting a service provider for the packet switched data service, connecting a session to the selected service provider, metering the session, generating billing information from the metering, and allocating the billing information to appropriate parties.

Embodiments may include one or more of the following.

The request may be from a user. Selecting may also include authenticating access for the user to the service provider. Selecting may also include determining whether the request is for the selected service provider and/or determining authorization for the user to the selected service.

Metering may include monitoring the session between the user and the selected service provider.

An appropriate party may be a network provider, the user and/or the selected service provider.

Embodiments of the invention may have one or more of the following advantages.

The method provides a monitoring and billing technique that combines network usage and service usage.

The technique provides transaction-based services (push or pull) in a context of packet switched data services over a wireless network where a network operator can directly bill a user of the packet switched data services.

A technique of operating a wireless network that is capable of carrying packet switched data is provided so that one or more packet switched data services on the network can be charged on a transaction basis to a user by a network operator.

The technique allows the user of a wireless network to obtain and use packet switched data services of a multiplicity of service providers while being billed for a cost of each transaction and associated cost of the network service in a single invoice by the operator of the network.

A provider of transaction based packet switched data services may be selected from a universe of service providers that are able to furnish a requested packet switched data service, and can be an operator of the network and/or third parties.

An operator of a wireless network charges a user account with billing units based upon network usage and packet switched data service usage, such as packet volume, user location, time of day, type of service provided, and user class, over a duration of a user session. The payments by the user to the operator of the network are reconciled between the operator and the service provider.

### BRIEF DESCRIPTION OF THE DRAWINGS

FIG. 1 is a block diagram of a wireless network.

FIG. 2 is a flow diagram of transaction based packet switched data service process.

### DETAILED DESCRIPTION

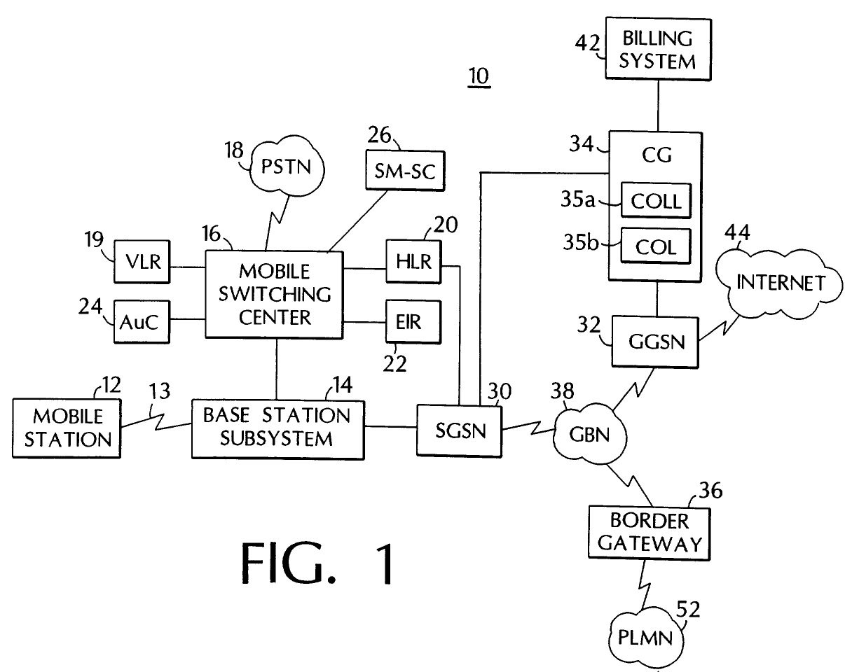

Referring to FIG. 1, a General Packet Radio System (GPRS) enabled Global System for Mobile communication (GSM) network 10 includes a Mobile Station (MS) 12. Although only one MS 12 is shown, the network 10 more typically includes a number of mobile stations. The MS 12 is commonly a digital telephone handset or other handheld digital device, such as a wireless enabled personal digital assistant (PDA).

The MS 12 communicates over an air interface 13 to a Base Station Subsystem (BSS) 14. The BSS 14 is responsible for controlling the air interface 13 operations of the network 10. The BSS 14 includes a Base Transceiver Station (BTS) (not shown) and a Base Station Controller (BSC) (not shown). The BTS is a radio transmitter/receiver and is located in its own cell or area of effect. The BTS has certain radio frequencies within a GSM band assigned to it. The BSC usually manages several BTSs and is the command and control for its dependent cells. Functions include radio channel allocation, call control and communications with a Mobile Switching Center (MSC) 16.

For circuit switched voice or data traffic, the BSC of the BSS 14 routes a circuit to the MSC 16. The MSC 16 routes traffic to an external network such as Public Switched Telephone Network (PSTN) 18 for land station-to-mobile station calls, mobile station-to-land station calls, or other mobile networks connected to the PSTN 18. The MSC 16 also manages authorization, authentication, and accounting functions for provided services.

The network 10 includes databases for enabling CSD services, e.g., a Visiting Location Register (VLR) 19, a Home Location Register (HLR) 20, an Equipment Identity Register (EIR) 22 and an Authentication Center (AuC) 24. The HLR 20 is a database (which can be distributed geographically) of all the subscribers on the network 10. The HLR 20 also includes information such as a current (or last known) handset whereabouts.

A complement of the HLR 20 is the VLR 19. Where as the HLR 20 is geographically distributed, and may not even be implemented at a particular MSC 16, it is usual for the VLR 19 to be located with each MCS 16. This greatly simplifies the routing of calls around the network 10. The network 10 also includes a Short Message Service Center (SM-SC) 26 that manages a short messaging service. The SM-SC 26 provides access and store-and-forward functions for short text/data messages in GSM, DCS (Digital Cellular Standard), PCS (Personal Communication System), CDMA (Code Division Multiple Access) and D-AMPS (Digital Advanced Mobile Phone Service) mobile networks.

The network 10 further includes a Packet Control Unit (PCU)(not shown), a Serving GPRS Support Node (SGSN) 30, a Gateway GPRS Support Node (GGSN) 32, a Charging Gateway (CG) 34, a Border Gateway (BG) 36, and a GPRS Backbone Network (GBN) 38.

The PCU (not shown), which is implemented as part of the BSS 14, provides a packet switched data interface for the circuit switched BSC of the BSS 14. The PCU also performs set up, supervision, and disconnection functions for packet switched calls. The PCU separates packet data and circuit-switched data when it is received from the MS 12 and multiplexes the different data streams from circuit-switched and packet-switched core networks into common streams going down to the cells.

The SGSN 30 interfaces between the GBN 38 and a radio portion of the network 10 and switches the data packets via GBN 38 to the correct BSS 14. The SGSN 30 performs, for packet switched services, ciphering and authentication, session management, mobility management, and logical link management through the network 10 to MS 12. The SGSN 30 also communicates with the HLR 20.

The GGSN 32 is a gateway node between the GBN 38 and an external Packet Data Network (PDN), such as Internet 44. When the PDN is an external Internet Protocol (IP) network like the Internet 44, the GGSN 32 appears to the external IP network as an IP router serving an IP address of the Mobile Station 12. The GGSN 32 may include firewalling and packet filtering functions. The GGSN 32 also determines, for any external connection, the correct SGSN 30 to assign for any Mobile Station 12.

The SGSN 30 and the GGSN 32 register all possible aspects of a GPRS user's behavior and generate billing information accordingly. The billing information is gathered in Charging Data Records or Call Data Records (CDRs). CDRs may accumulate information based on a number of parameters, such as volume, duration, time, final destination, location, quality of service, SMS, served IMSI/subscriber, reverse charging, free of charge, flat rate, and bearer service.

The Border Gateway (BG) 36 is a gateway system between different Public Land Mobile Networks (PLMNs) 52. One purpose of BG 36 is to provide a secure connection over an inter-PLMN backbone network for packet switched data. The BG 36 virtually extends the GBN 38 to SGSNs that are physically located in different PLMNs 52 through connection to their BGs. Like the GGSN 32, the CG 36 appears as an IP router if the inter-PLMN network is an IP network. The BG 36 may also include security and firewalling functions.

The Charging Gateway (CG) 34 collects and processes all of the charging or billing information for the GPRS packet switched data handled by the network 10 in a collection process 35a. The collection process 35a collects charging information in the form of Call Detail Records (CDRs) from the SGSN 30 (referred as S-CDRs) and the GGSN 32 (referred to as G-CDRs) for all of the packet switched data. The S-CDRs from the SGSN 30 and the G-CDRs from the GGSN 32 are sent to a collation process 35b. The collation process 35b collates collected CDRs into a single composite CDR stream that is sent to a Billing System 42. The collation process 35b also processes the received CDR information to check for record duplication, information correlation, validation, and can accumulate information on user sub-sessions (also referred to as purchases) within a single user session. A sub-session represents the user accessing different services with a single user session.

In another example, the single composite CDR stream is sent through a Billing Mediation System (not shown) and then on to the Billing System 42.

In an example, the network 10 is utilized to provide transaction based packet switched data services to a user on the basis of purchased services being supplied by a service provider to the user. The service provider may be a single third party, multiple third parties, and/or an operator of the network 10. The purchased service may be an application-based service, e.g., content of a service or a user interactive service, a product, e.g., a software program, a license, e.g., rights to use a software program, goods for later delivery, e.g., items for pickup by a user at a facility, vending outlet or sales location, or for delivery by the service provider to the user's location. The network service for the packet switched data transport that is involved in the delivery of the service is bundled in the total purchase price of the service, i.e., the user does not incur a separate charge or toll for any network service necessary to fulfill the purchase request. Prior to using the service, the user is aware that by connection to the service the services are offered on a fee basis and include bundled network service and transport charges. In an example, the user may be notified at the time of requesting a service that it is transaction based on a fee basis.

An operator of the network 10 manages and controls the transaction based packet switched data services. This includes any and all unique network addresses that identify the packet switched data service, the policy decisions that determine how, and to which, packet switched data service provider the user is directed, and the policy decisions that determine how the user is to be billed and on what basis, and any policy decisions that are entrusted to the service provider. The policy decisions for selection and billing may include rules that incorporate any pre-agreements between the operator and third parties, such as service providers, as to the selection of the service provider and the method and basis of payment for the user. For example, the policy decision of which service provider to make a connect to may be made at the time of the service request based upon such factors as the user identity, the location of the user, time of day, user class, service provider class, network conditions, pre-agreement rules, and/or governmental regulations.

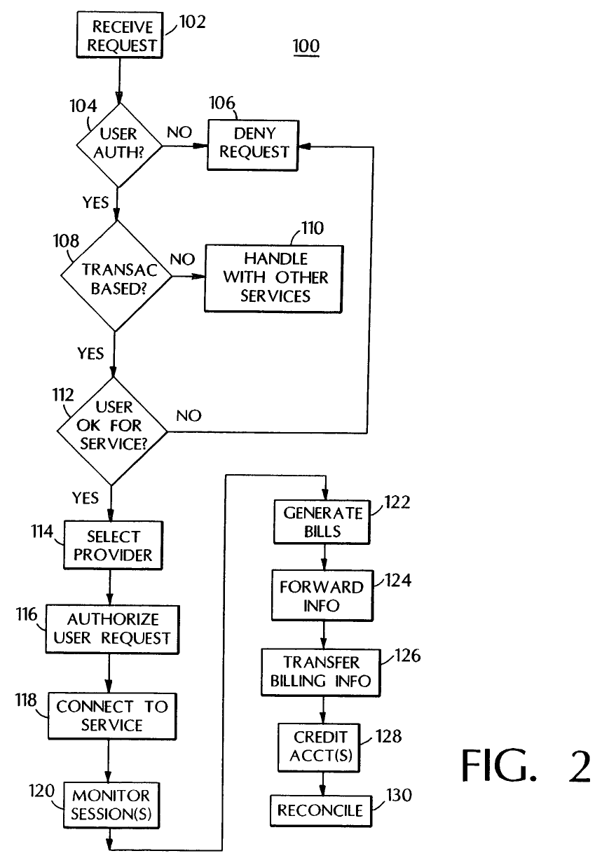

Referring to FIG. 2, a transaction based packet switched data service process 100 includes receiving (102) a request from a user for a packet switched data service. The service request may originate from the user through the air interface to the network 10 or the service request may come in response to a push operation by a service provider inviting the user to purchase its service. A push operation is one in which the sponsor initiates activity.

The process 100 determines (104) whether the user is authorized to access the network 10 for transaction-based packet switched data services. User class information and location information needed to make later policy decisions about the requested transaction-based packet switched data service collected during the determination (104). If the user is not authorized to access the network 10 the process 100 denies (106) the user request.

If the user is authorized to access the network 10 for transaction-based packet switched data services, the process 100 determines (108) whether requested service is a transaction-based packet switched data service. If the service request is not for a transaction-based packet switched data service, the process 100 handles (110) the user request with other service request processes.

If the service request is for a transaction-based packet switched data service, the process 100 determines (112) whether the user is authorized to access the specific requested transaction-based packet switched data service. If the user is not authorized to access the specific requested transaction-based packet switched data service, the process 100 denies (106) the user request.

If the user is authorized to access the specific requested transaction-based packet switched data service, the process 100 selects (114) a service provider for the specific requested transaction-based packet switched data service. The selection (114) is made in conjunction with a stored rule base implementing policy decisions of an operator of the network 10 based on one or more factors. Factors may include a user identity, a location of the user, a time of day, a user class, a service provider class, network conditions, pre-agreement rules, and/or governmental regulations. For example, if the operator of network 10 would normally supply specific requested transaction-based packet switched data service, the rule base selection preferentially chooses the operator as the service provider.

The process 100 authorizes (116) the user's request. Authorization (116) may include participation by the service provider and/or the operator of the network 10. The service requested by the user is transaction-based so authorization (116) involves determining if the user making the request has sufficient credit or payment facilities to pay for the anticipated debt resulting from the service being provided. If the user is not authorized to make the purchase of the selected transaction-based service the process 100 denies (106) the service to the user.

If the user is authorized to proceed with the purchase of the selected transaction-based service, the process 100 connects (118) the user through SGSN 30, GBN 38, and CGSN 32 to the identified service provider and a packet switched data service session is initiated. The initiated transaction-based packet switched data service may encompass one or more purchases of transaction based services by the user from the identified service provider. The process 100 monitors (120) each individual purchase session within a single user session and generates (122) billing and other information for the purchase or purchases. During each purchase session, the process 100 may forward (124) billing information to the billing node 42 in a real time, or near real time. The type of billing information and other information will depend upon the type of packet switched data service provided and the provider. In an example, the type of information gathered will be a policy decision of the network operator. In the example of a third party provider, the type of information gathered will usually be based upon a pre-agreement between the operator of the network 10 and the third party provider. For example, purchase authorization may limit the maximum network resources allowed to be used in attempts to deliver the transaction based service. A pre-agreed policy may determine under what conditions the service may be delivered and what constitutes the limits of reasonable attempts to deliver the service by the network operator.

For example, if poor network conditions result in an unacceptably high number of packet retransmissions during the service delivery attempt due to unrecoverable packet error conditions between the provider and the user, pre-agreed policy rules may include a threshold at which the service delivery attempt is aborted, the purchase canceled and the purchase session is prematurely declared complete. Under more typical “normal” conditions, a purchase session is determined as complete when the delivery of the transaction-based service is finished.

When the purchase session is complete, the process 100 transfers (126) the billing information and other information using CDRs 24 by way of Charge Data Records (CDRs) to the billing node 42.

The SGSN 30 and the GGSN 32 register all possible aspects of a GPRS user's behavior and generate billing information accordingly. The billing information is gathered in Charging Data Records or Call Data Records (CDRs). CDRs may accumulate information based on a number of parameters, such as volume, duration, time, final destination, location, quality of service, SMS, served IMSI/subscriber, reverse charging, free of charge, flat rate, and bearer service.

The process 100 credits (128) billing units to an account of the user for payment and information units stored for information transfer. There may also be an exchange of information between the service provider and network operator related to the purchase session completion. The process 100 reconciles (130) any usage information to service provider records.

If the service session between the user and service provider encompasses multiple purchase sessions, the user may choose to make further transaction based service requests If the user has no further requests and/or all purchase sessions are completed, then the service session is complete. If the user chooses to make further and/or multiple purchase requests from the same service provider during the same service session, then these additional requests are handled by process 100.

1. A method comprising:
in a wireless network, receiving a user request for a packet switched data service;
determining a provider for the service according to stored policies; and
determining a billing arrangement for the service according to the stored policies.

2. The method of claim 1 in which the stored polices include how the user is to be billed and a basis for the billing.

3. The method of claim 2 in which the stored polices include policy decisions that are entrusted to the provider.

4. The method of claim 1 in which the stored polices include pre-arrangements between an operator of the network and the provider.

5. The method of claim 1 in which the stored policies include matching a provider to a user's time of connection.

6. The method of claim 1 in which the stored policies include matching a provider to a user's location.

7. The method of claim 1 in which the stored policies include matching a provider to a time of day.

8. The method of claim 1 in which the stored policies include matching a provider to a user class.

9. The method of claim 1 in which the stored policies include matching a provider to a service class.

10. The method of claim 1 in which the stored policies include matching a provider to network conditions.

11. The method of claim 1 further comprising:
determining whether the user is authorized to use the service.

12. The method of claim 11 in which determining comprises:
checking a user account for payment history.

13. The method of claim 11 further comprising:
billing the user upon completion of a user session; and
reconciling billing between a network operator and the provider.

14. The method of claim 13 in which the user session includes multiple transaction sessions.

15. The method of claim 1 in which the wireless network is a second generation wireless network.

16. The method of claim 1 in which the wireless network is a Global System for Mobile communication (GSM) network.

17. The method of claim 16 in which the GSM network is General Packet Radio System (GPRS) enabled.

18. The method of claim 1 in which the wireless network is a Time Division Multiple Access (TDMA) network.

19. The method of claim 1 in which the wireless network is a Code Division Multiple Access (CDMA) network.

20. The method of claim 1 in which the wireless network is a Universal Mobile Telecommunications System (UMTS) network.

21. The method of claim 1 in which the wireless network is a TETRA network.

22. The method of claim 1 in which the wireless network is a Tetrapol network.

23. The method of claim 1 in which the wireless network is a DECT network.

24. The method of claim 1 in which the wireless network is an AMPS network.

25. The method of claim 1 in which the wireless network is a wireless local area network (WLAN).

26. The method of claim 1 in which the wireless network is a third generation wireless network.

27. A method of managing a General Packet Radio System (GPRS) enabled Global System for Mobile communication (GSM) network comprising:
receiving a user request for a packet switched data service;
determining a provider for the service according to stored policies; and
determining a billing arrangement for the service according to the stored policies.

28. The method of claim 27 in which the stored polices include how the user is to be billed and a basis for the billing.

29. The method of claim 28 in which the stored polices include policy decisions that are entrusted to the provider.

30. The method of claim 27 in which the stored polices include pre-arrangements between an operator of the network and the provider.

31. The method of claim 27 in which the stored policies include matching a provider to a user's time of connection.

32. The method of claim 27 in which the stored policies include matching a provider to a user's location.

33. The method of claim 27 in which the stored policies include matching a provider to a time of day.

34. The method of claim 27 in which the stored policies include matching a provider to a user class.

35. The method of claim 27 in which the stored policies include matching a provider to a service class.

36. The method of claim 27 in which the stored policies include matching a provider to network conditions.

37. The method of claim 27 further comprising:
determining whether the user is authorized to use the service.

38. The method of claim 37 in which determining comprises:
checking a user account for payment history.

39. The method of claim 37 further comprising:
billing the user upon completion of a user session; and
reconciling billing between a network operator and the provider.

40. The method of claim 39 in which the user session includes multiple transaction sessions.

41. A method comprising:
in a General Packet Radio System (GPRS) enabled Global System for Mobile Communication (GSM) network, collecting call data
records (CDRs) from a Serving GPRS support node in the network;
sending the CDRs to a charging gateway in the network;
processing the CDRs for packet switched data into a single composite CDR stream in the charging gateway; and
processing the single composite CDR stream in a billing system.

42. The method of claim 41 in which collecting further comprises:
collecting CDRs from a GPRS support node.

43. The method of claim 41 in which processing the CDRs further comprises:
augmenting the CDRs for packet switched data in a billing mediation node.

44. The method of claim 41 in which the single composite CDR stream represents a user session.

45. The method of claim 44 in which the user session includes a plurality of individual purchase sessions.

46. The method of claim 41 in which processing the single composite CDR stream comprises:
checking for records duplication;
correlating information; and
validating.

47. A method of providing a sponsored packet switch data service comprising:
in a GPRS enabled GSM network, receiving a request for a packet switched data service;
selecting a service provider for the packet switched data service;
connecting a session to the selected service provider;
metering the session;
generating billing information from the metering; and
allocating the billing information to appropriate parties.

48. The method of claim 47 in which the request is from a user.

49. The method of claim 48 in which selecting further comprises:
authenticating access for the user to the service provider.

50. The method of claim 49 in which selecting further comprises:
determining whether the request is for the selected service provider.

51. The method of claim 50 in which selecting further comprises:
determining authorization for the user to the selected service.

52. The method of claim 48 metering comprises:
monitoring the session between the user and the selected service provider.

53. The method of claim 47 in which an appropriate party is a network provider.

54. The method of claim 47 in which an appropriate party is the user.

55. The method of claim 47 in which an appropriate party is the selected service provider.

56. The method of claim 47 in which the appropriate parties are the user, a network provider and the selected service provider.
